(19) United States
(12) Patent Application Publication
(10) Pub. No.: US 2026/0252071 A1
(43) Pub. Date: Aug. 27, 2026

(54) APPARATUS AND SYSTEM FOR DETECTING ABNORMALITIES IN INDUSTRIAL EQUIPMENT USING DEEP LEARNING, MACHINE LEARNING, AND STATISTICAL MODELS

(71) Applicant: AINATION CO., LTD., Seocho-gu, Seoul (KR)

(72) Inventors: Jihoon KWAK, Seocho-gu, Seoul (KR); Hojin CHOI, Seocho-gu, Seoul (KR); Eun Yeong KANG, Seocho-gu, Seoul (KR); Seung Min LEE, Seocho-gu, Seoul (KR)

(21) Appl. No.: 18/854,583

(22) PCT Filed: Oct. 25, 2023
(86) PCT No.: PCT/KR2023/016611

§ 371 Date: Oct. 7, 2024

(30) Foreign Application Priority Data
Oct. 26, 2022 (KR) 10-2022-0139086

(51) Int. Cl. G05B 23/02

(52) U.S. Cl. CPC G05B 23/0281

(57) ABSTRACT

The present specification discloses an anomaly detection apparatus and system for industrial equipment using deep learning, machine learning, and statistical models. According to one aspect of the present embodiment, an anomaly detection apparatus for detecting anomalies occurring in industrial equipment comprises: a communicator configured to receive an input value input into the industrial equipment or an output value output from the industrial equipment; an anomaly detector configured to detect multiple types of anomalies occurring in the industrial equipment from the input value or output value received by the communicator; and a controller configured to control the operations of the communicator and the anomaly detector.

### TECHNICAL FIELD

The present embodiment relates to an apparatus and system capable of comprehensively detecting anomalies in industrial equipment using deep learning models, machine learning models, and statistical models.

### BACKGROUND ART

The content described in this section is merely provided as background information for the present embodiment and does not constitute prior art.

With the advancement of industrial processes, industrial control systems have evolved to allow the remote control of hardware-based industrial equipment using computer systems.

In a typical industrial control system, most control operations are automatically performed by remote terminals and Programmable Logic Controllers (PLC), and the control commands that an operator can issue are usually limited to basic task changes or management-level task adjustments.

The data acquisition in an industrial control system starts from remote terminals or Programmable Logic Controllers (PLC). This includes tasks such as reading instrument measurements required by the industrial control system or reporting the status of each piece of equipment. The acquired data is then converted into a human-understandable form at the control center, allowing operators to make appropriate decisions for system management. Administrators can verify the system status from the converted data and take necessary control actions.

Conventional control systems for equipment control primarily monitored simple numerical values of the equipment output and determined errors only by comparing these values to predefined thresholds. Alternatively, they assessed anomalies by comparing specific equipment or component metrics against a range of values predefined uniformly by the equipment manufacturer, then notifying the administrator. In other words, if the output value of the equipment or its average over a certain period exceeded or significantly fell below the set threshold, the system would merely judge it as an anomaly and notify the administrator.

Anomalies occurring in equipment can manifest in various forms, such as sudden overshooting of output values or anomalous oscillation. While conventional control systems could easily detect changes in numerical values, they had difficulty detecting such diverse forms of anomalies.

### DISCLOSURE OF INVENTION

### Technical Problem

An object of one embodiment of the present invention is to provide an apparatus and system for detecting anomalies in industrial equipment by utilizing deep learning, machine learning, and statistical models to maximize the detection of anomalies occurring in industrial equipment.

### Solution to Problem

According to one aspect of the present embodiment, an anomaly detection apparatus for detecting anomalies occurring in industrial equipment comprises: a communicator configured to receive an input value input into the industrial equipment or an output value output from the industrial equipment; an anomaly detector configured to detect multiple types of anomalies occurring in the industrial equipment from the input value or output value received by the communicator; and a controller configured to control the operations of the communicator and the anomaly detector.

According to one aspect of the present embodiment, wherein the anomaly detector comprises: an overshooting detector configured to detect an overshooting anomaly occurring in the input value or output value; an anomalous oscillation detector configured to detect an anomalous oscillation occurring in the input value or output value; and an average change detector configured to detect an average change anomaly occurring in the input value or output value.

According to one aspect of the present embodiment, wherein the overshooting detector and the oscillation detector are configured to: extract one or more feature points in a latent space from the input value or output value received from the industrial equipment, and detect the overshooting anomaly or anomalous oscillation by using the difference between a restored value, which is restored from the extracted feature points, and the original input value or output value received from the industrial equipment.

According to one aspect of the present embodiment, wherein the overshooting detector is configured to: extract one or more feature points in a latent space from the input value or output value received from the industrial equipment using a CNN model, and then restore the feature points.

According to one aspect of the present embodiment, wherein the oscillation detector is configured to: extract one or more feature points in a latent space from the input value or output value received from the industrial equipment using an LSTM model, and then restore the feature points.

According to one aspect of the present embodiment, wherein the average change detector is configured to: set a normal range corresponding to data without anomalies based on the input value or output value received from the industrial equipment over a predetermined period, and detect an average change anomaly based on whether the input value or output value received from the industrial equipment deviates from the normal range.

According to one aspect of the present embodiment, wherein the average change detector is configured to: predict the trend of data changes based on the input value or output value received from the industrial equipment over a predetermined period, and detect an average change anomaly based on whether there is a difference between the input value or output value received from the industrial equipment and the predicted trend.

According to one aspect of the present embodiment, wherein the average change detector is configured to: predict the trend of data changes based on the input value or output value received from the industrial equipment over a predetermined period using an LSTM model.

According to one aspect of the present embodiment, wherein the anomaly detector further comprises: a short-term anomaly detector configured to detect anomalies in the data within the input value or output value received from the industrial equipment; and a long-term anomaly detector configured to calculate statistics of the input value or output value received over a predetermined period, and detect anomalies in the input value or output value received from the industrial equipment using the calculated statistics.

According to one aspect of the present embodiment, wherein the short-term anomaly detector uses a machine learning model.

According to one aspect of the present embodiment, wherein the long-term anomaly detector uses a statistical model.

According to one aspect of the present embodiment, An anomaly detection system for industrial equipment, comprising: industrial equipment; an anomaly detection apparatus configured to receive an input value input into the industrial equipment or an output value output from the industrial equipment, detect multiple types of anomalies occurring in the industrial equipment from the received input value or output value, and transmit the detection results externally; and an administrator terminal configured to receive information on the occurrence of anomalies in the industrial equipment from the anomaly detection apparatus and enable an administrator to manage the industrial equipment in which the anomalies have occurred.

### Advantageous Effects of Invention

As described above, one aspect of the present embodiment has the advantage of maximizing the detection of anomalies occurring in industrial equipment by utilizing deep learning, machine learning, and statistical models.

### BRIEF DESCRIPTION OF DRAWINGS

FIG. 1 is a diagram illustrating the configuration of an anomaly detection system for industrial equipment according to an embodiment of the present invention.

FIG. 2 is a diagram illustrating the configuration of an anomaly detection apparatus according to an embodiment of the present invention.

FIG. 3 is a graph illustrating the forms of anomalies occurring in industrial equipment.

FIG. 4 is a diagram illustrating the detection mechanisms of the overshooting detector and the anomalous oscillation detector according to an embodiment of the present invention.

FIG. 5 is a graph illustrating an example of an anomalous characteristic detected by the overshooting detector according to an embodiment of the present invention.

FIG. 6 is a graph illustrating the ROC curve of the overshooting detector according to an embodiment of the present invention.

FIG. 7 is a graph illustrating an example of an anomalous characteristic detected by the anomalous oscillation detector according to an embodiment of the present invention.

FIG. 8 is a graph illustrating an example of an anomalous characteristic detected by the average change detector according to an embodiment of the present invention.

FIG. 9 is a schematic diagram illustrating a method for detecting anomalous characteristics by the short-term data detector according to an embodiment of the present invention.

FIG. 10 is a graph illustrating an example of an anomalous characteristic detected by the long-term data detector according to an embodiment of the present invention.

### BEST MODE FOR CARRY OUT THE INVENTION

According to an aspect of the present embodiment, an anomaly detection apparatus for detecting anomalies occurring in industrial equipment is provided, comprising: a communicator configured to receive input values input to the industrial equipment or output values output from the industrial equipment; an anomaly detector configured to detect a plurality of types of anomalies occurring in the industrial equipment from the input values or output values received by the communicator; and a controller configured to control the operations of the communicator and the anomaly detector.

### MODE FOR CARRY OUT THE INVENTION

The present invention is subject to various modifications and can have multiple embodiments. Specific embodiments are illustrated and described in detail in the drawings. However, this is not intended to limit the invention to specific embodiments, and it should be understood to include all modifications, equivalents, and alternatives falling within the spirit and scope of the invention. Similar reference numerals are used for similar components throughout the drawings.

Terms like first, second, A, B, etc., may be used to describe various components, but these components should not be limited by these terms. These terms are only used to distinguish one component from another. For instance, a first component may be termed a second component without departing from the scope of the present invention, and similarly, the second component may be termed the first component. The term “and/or” includes any and all combinations of one or more of the associated listed items.

When a component is referred to as being “connected to” or “coupled to” another component, it can be directly connected or coupled to the other component, or intervening components may be present. In contrast, when a component is referred to as being “directly connected to” or “directly coupled to” another component, there are no intervening components present.

The terminology used herein is for the purpose of describing particular embodiments only and is not intended to limit the invention. Singular forms include plural forms unless the context clearly dictates otherwise. The terms “comprise” and “have” as used in this specification, specify the presence of stated features, integers, steps, operations, components, parts, or combinations thereof, but do not preclude the presence or addition of one or more other features, integers, steps, operations, components, parts, or combinations thereof.

Unless otherwise defined, all terms including technical and scientific terms used herein have the same meaning as commonly understood by one of ordinary skill in the art to which this invention belongs.

Terms such as those defined in commonly used dictionaries should be interpreted as having a meaning consistent with their meaning in the context of the relevant art and should not be interpreted in an idealized or overly formal sense unless expressly defined herein.

Moreover, each component, process, step, or method described in the various embodiments of the present invention can be shared within the scope that does not cause technical contradictions.

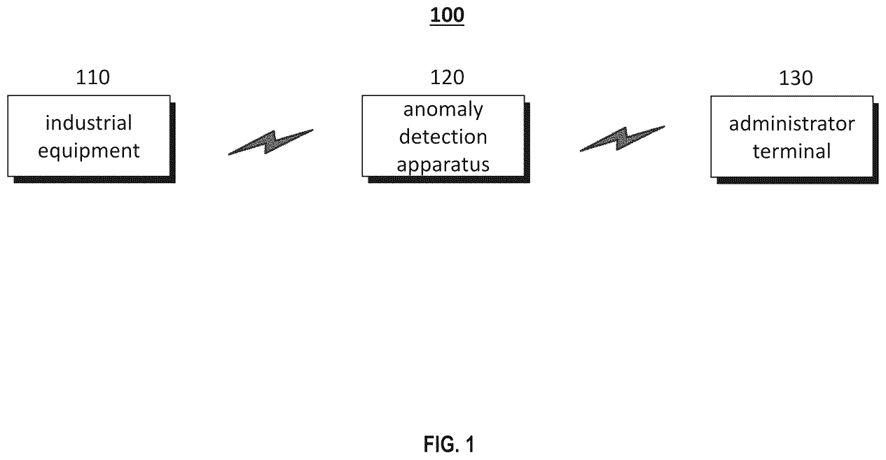

FIG. 1 is a diagram illustrating the configuration of an anomaly detection system for industrial equipment according to an embodiment of the present invention.

Referring to FIG. 1, an anomaly detection system 100 for industrial equipment according to an embodiment of the present invention comprises industrial equipment 110, an anomaly detection apparatus 120, and an administrator terminal 130.

The industrial equipment 110 refers to machinery or facilities deployed and operated in various industrial fields, such as manufacturing or construction, to achieve diverse objectives. The industrial equipment 110 includes numerous components or modules tailored to the specific purpose of each device, performing various operations such as processing or assembling specific materials into predetermined states. The industrial equipment 110 is powered to operate, and once powered, it outputs various forms of output values, such as sensing values for sensors or torque for motors.

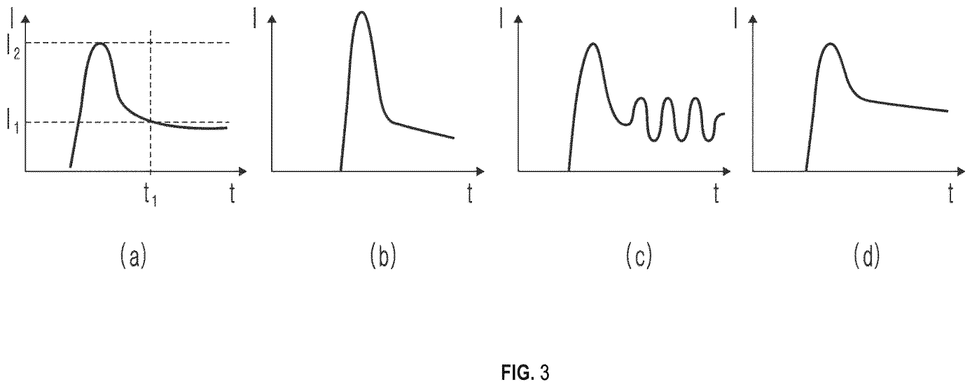

The anomaly detection apparatus 120 detects whether anomalies have occurred in various components or modules within the industrial equipment 110 (hereinafter abbreviated as “industrial equipment”). The anomaly detection apparatus 120 receives input values such as power supplied to the industrial equipment 110 or output values generated from the industrial equipment 110, and detects whether an anomaly has occurred in the industrial equipment. When an anomaly occurs in the industrial equipment, it inevitably leads to anomalies in the input values (e.g., power) or output values. Considering this, the anomaly detection device 120 receives input values or output values from the industrial equipment 110 to detect anomalies. Although the nature of anomalies occurring in the industrial equipment can vary, they can be clustered into three groups as illustrated in FIG. 3.

FIG. 3 is a graph illustrating the forms of anomalies occurring in industrial equipment.

FIG. 3 (a) is a graph illustrating the current values applied per unit time to initially operate the industrial equipment 110 without anomalies. During the initial operation of the industrial equipment, from the moment the current is applied until a certain time (t₁), a relatively larger amount of current (I₂) is applied compared to the average amount (I₁). As time progresses, the current stabilizes, and after the certain time (t₁), the average amount of current (I₁) is applied consistently.

One type of anomaly occurring in the industrial equipment 110 is overshooting. This occurs when an excessively large or excessively small amount of power is applied to the industrial equipment at any given point compared to the normal (non-abnormal) input power. This example is illustrated in FIG. 3 (b). From the moment the current is applied to the industrial equipment until a certain time (t₁), the amount of current applied is significantly larger than the current amount (I₂) applied to normal industrial equipment. However, this is not limited to this scenario; the magnitude of the applied power can become significantly larger or smaller compared to the power applied to normal industrial equipment at any stabilized point or any other time.

Another type of anomaly is anomalous oscillation. As shown in FIG. 3 (c), this occurs when oscillations of a magnitude higher than the typically expected level (amplitude) occur at times when no oscillations are expected in the power input to the normal industrial equipment. The occurrence of these oscillations can happen at any arbitrary point in time.

The remaining type of anomaly is the increase or decrease in the average value. As illustrated in FIG. 3 (d), this occurs when the magnitude of the power applied at any given point deviates by more than a predetermined error range compared to the normal state, without the occurrence of overshooting or anomalous oscillations. The increase or decrease in the average value mainly occurs after the applied power has stabilized.

In FIG. 3, the types of anomalies are described as occurring in the power applied to the industrial equipment for the sake of explanation. However, these anomalies are examples provided for convenience. Anomalies can be detected by the input power applied to the industrial equipment, as well as by the output values generated from the industrial equipment.

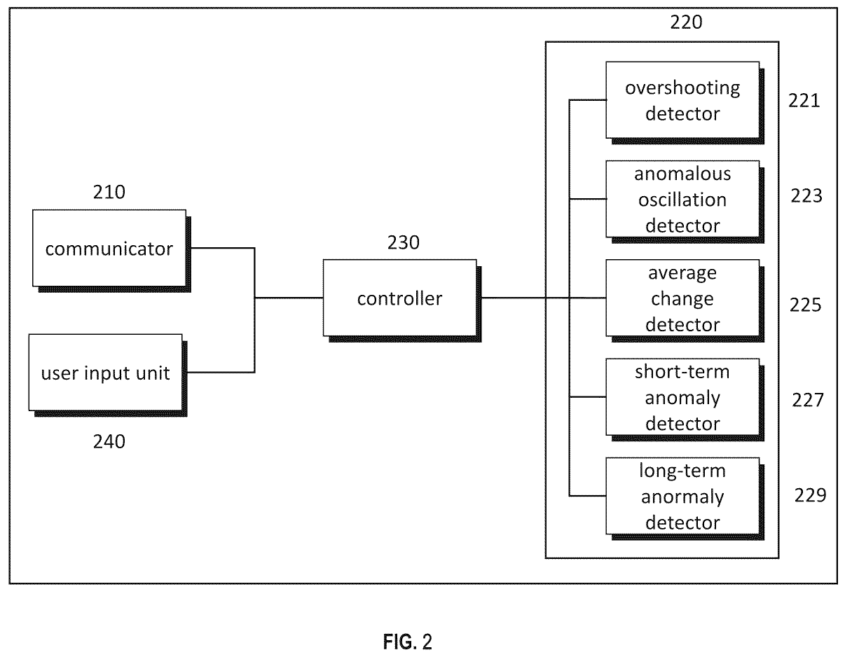

Referring again to FIG. 1, since it is difficult to detect various types of anomalies with a single detection method, the anomaly detection apparatus 120 employs multiple detection methods to detect various kinds of anomalies that may occur in the industrial equipment. The anomaly detection apparatus 120 not only detects all the aforementioned types of anomalies but also considers cases where it is necessary to quickly and immediately detect anomalies, even at the expense of some accuracy. There are also cases where it is necessary to detect anomalies occurring over a long period. The anomaly detection apparatus 120 categorizes most anomalies that may occur in industrial equipment into various cases and detects them using appropriate methods for each case. Specific details regarding this will be described later with reference to FIGS. 2 to 10.

The anomaly detection apparatus 120 communicates with the administrator terminal 130 and notifies it of any anomalies detected in the industrial equipment.

The administrator terminal 130 receives information from the anomaly detection apparatus 120 regarding the occurrence of anomalies in the industrial equipment, allowing the administrator to manage the affected industrial equipment. By using the administrator terminal 130, the administrator can identify the industrial equipment where anomalies have occurred. Additionally, the administrator can distinguish between various types of anomalies that may occur in the industrial equipment, facilitating easier and more efficient management of the industrial equipment.

FIG. 2 is a diagram illustrating the configuration of an anomaly detection apparatus according to an embodiment of the present invention.

Referring to FIG. 2, the anomaly detection apparatus 120 according to an embodiment of the present invention comprises a communicator 210, an anomaly detector 220, a controller 230, and a user input unit 240.

The communicator 210 receives input values input into the industrial equipment 110 or output values output from the industrial equipment 110. The communicator 210 performs wired or wireless communication with the industrial equipment 110 to receive these input or output values (hereinafter referred to as “original datas”). The communicator 210 receives original datas from the industrial equipment 110 so that the anomaly detector 220 can detect anomalies in the industrial equipment 110 based on changes in the input values input into the industrial equipment 110 or the output values output from the industrial equipment 110.

The communicator 210 transmits the detection results of the anomaly detector 220 to the administrator terminal 130. The communicator 210 performs wireless or wired communication to send the detection results from the anomaly detector 220 to the administrator terminal 130.

The anomaly detector 220 detects multiple types of anomalies from the received original datas. As previously described, although anomalies can have various patterns, they can be clustered into three groups. By detecting all clustered types of anomalies, the anomaly detector 220 increases the detection rate and accuracy of anomalies occurring in the industrial equipment 110. The anomaly detector 220 includes an overshooting detector 221, an oscillation detector 223, an average change detector 225, a short-term anomaly detector 227, and a long-term anomaly detector 229.

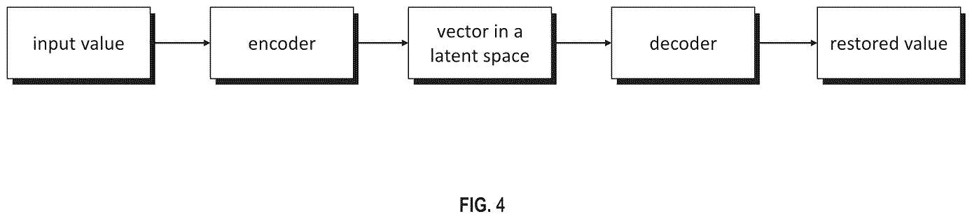

The overshooting detector 221 detects whether an overshooting anomaly has occurred in the industrial equipment 110 by using the difference between the received original data and the restored value, which is obtained after extracting feature points of the original data in the latent space. The process by which the overshooting detector calculates the restored value is illustrated in FIG. 4.

FIG. 4 is a diagram illustrating the detection mechanisms of the overshooting detector and the anomalous oscillation detector according to an embodiment of the present invention.

Referring to FIG. 4, the overshooting detector 221 (or the oscillation detector) receives the original data. The overshooting detector 221 uses an encoder and a decoder to receive the (original) signal and then restore the signal. The overshooting detector 221 converts the input signal into a feature vector in a relatively low-dimensional latent space using the encoder and then restores it to an output signal of the input signal dimension using the decoder. The overshooting detector 221 is trained with learning data consisting only of normal signals so that the difference between the input signal and the output signal is minimized. This training ensures that the feature vector in the latent space represents the common characteristics of normal signals.

Once training is complete, when a signal with characteristics of a normal signal is input into the overshooting detector 221, the encoder and decoder will function as trained to output a signal similar to the input signal. Conversely, if an anomalous signal is input into the encoder, although features will be extracted into the lower-dimensional latent space, only the common characteristics of normal signals will be extracted, and the features of the anomalous signal will not be fully captured. As a result, the signal restored by the decoder will differ from the original signal.

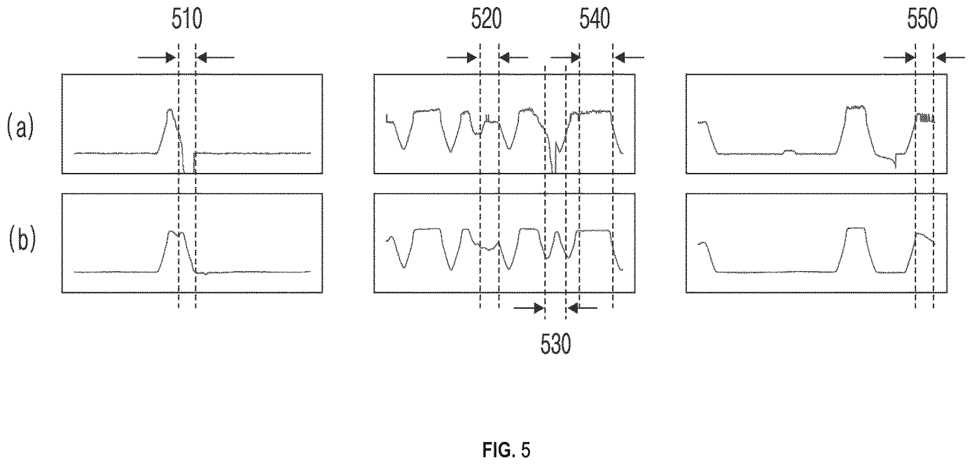

The overshooting detector 221 uses a deep learning model, specifically Convolutional Neural Networks (CNN), to implement the encoder and decoder, thereby obtaining the restored value from the original data. The restoration by CNN has excellent reproducibility in capturing the overall shape of the original data. Consequently, the overshooting detector 221 has relatively higher accuracy in detecting overshooting anomalies, which manifest as shape anomalies in the data, while it has relatively lower accuracy in detecting oscillations that maintain the data shape but exhibit fluctuations. The overshooting detector 221 primarily detects overshooting anomalies in the original data by using the difference between the input value and the obtained restored value. Examples of detections by the overshooting detector 221 are illustrated in FIG. 5.

FIG. 5 is a graph illustrating an example of an anomalous characteristic detected by the overshooting detector according to an embodiment of the present invention.

Referring to FIG. 5, FIG. 5 (a) shows the original data, and FIG. 5 (b) shows the restored value. It can be observed that the overshooting anomalies (510, 520, 530) present in the original data are not reflected in the restored value. The overshooting detector 221 detects anomalies (overshooting) at points 510, 520, and 530 in the original data by identifying these differences between the original data and the restored value. Furthermore, the overshooting detector 221 can also detect anomalous oscillations (540, 550) from the differences between the original data and the restored value.

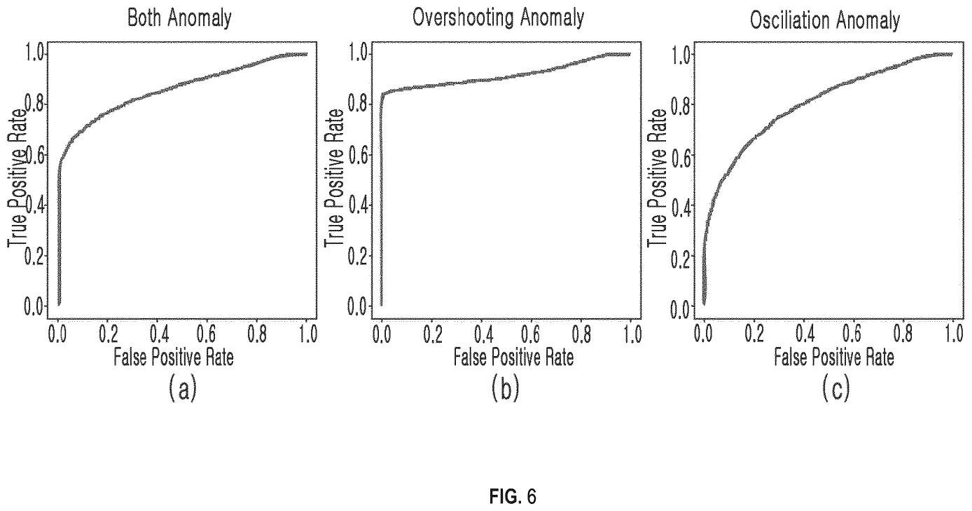

The overshooting detector 221, which detects anomalies in the original data through the aforementioned process, has a ROC (Receiver Operating Characteristic) curve as shown in FIG. 6.

FIG. 6 is a graph illustrating the ROC curve of the overshooting detector according to an embodiment of the present invention.

In the graph shown in FIG. 6, the x-axis represents the False Positive Rate (FPR), indicating the rate of incorrect detections, while the y-axis represents the True Positive Rate (TPR), indicating the rate of correct detections. A higher TPR indicates higher detection accuracy, and the closer the curve is to a right-angle shape towards the top left corner, the better the detection accuracy. FIG. 6 (b) illustrates the ROC curve for overshooting anomalies, FIG. 6 (c) shows the ROC curve for anomalous oscillation anomalies, and FIG. 6 (a) depicts the ROC curve for all types of anomalies. Using CNN, which excels at detecting overall shape changes, the overshooting detector 221 obtains restored values from the original data and detects differences between the original data and the restored values. This results in a relatively high detection rate for overshooting anomalies. The overshooting detector 221 achieves a high detection rate of over 91% for overshooting anomalies and a detection rate of over 80% for anomalous oscillation anomalies.

Referring back to FIG. 2, the anomalous oscillation detector 223 detects whether anomalous oscillations have occurred in the industrial equipment 110 by using the differences between the received original data and the restored value. Similar to the overshooting detector 221, the anomalous oscillation detector 223 calculates the restored value from the original data following the process illustrated in FIG. 4.

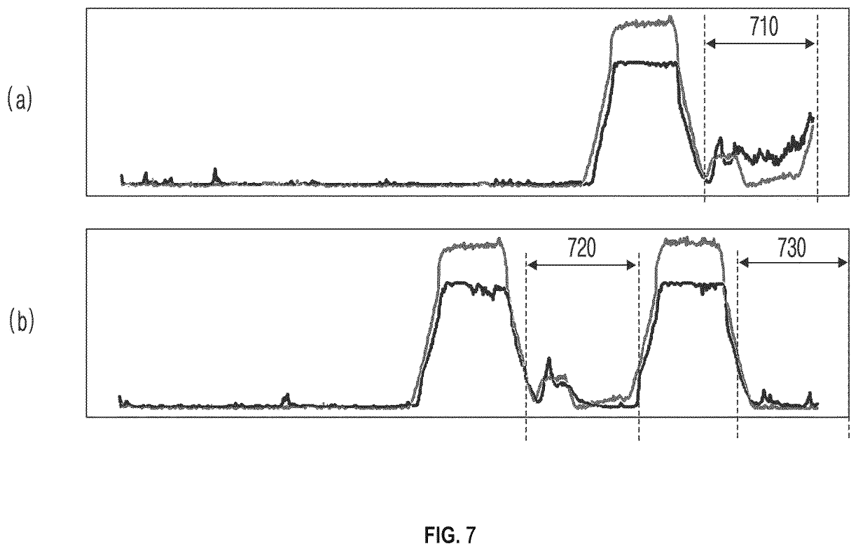

However, in this case, the anomalous oscillation detector 223 uses a deep learning model, LSTM (Long Short-Term Memory), to implement the encoder and decoder to calculate the restored value. Unlike CNN, LSTM is relatively better at detecting detailed changes in the data rather than overall shape changes. Consequently, the oscillation detector 223 produces restored values as shown in FIG. 7.

FIG. 7 is a graph illustrating an example of an anomalous characteristic detected by the anomalous oscillation detector according to an embodiment of the present invention.

The anomalous oscillation detector 223 is relatively accurate at detecting detailed changes within specific intervals, rather than differences in the overall shape or magnitude of the data. As a result, areas where oscillations occur in the original data will exhibit relatively different oscillations in the restored value, allowing the detection of anomalous oscillations (710 to 730).

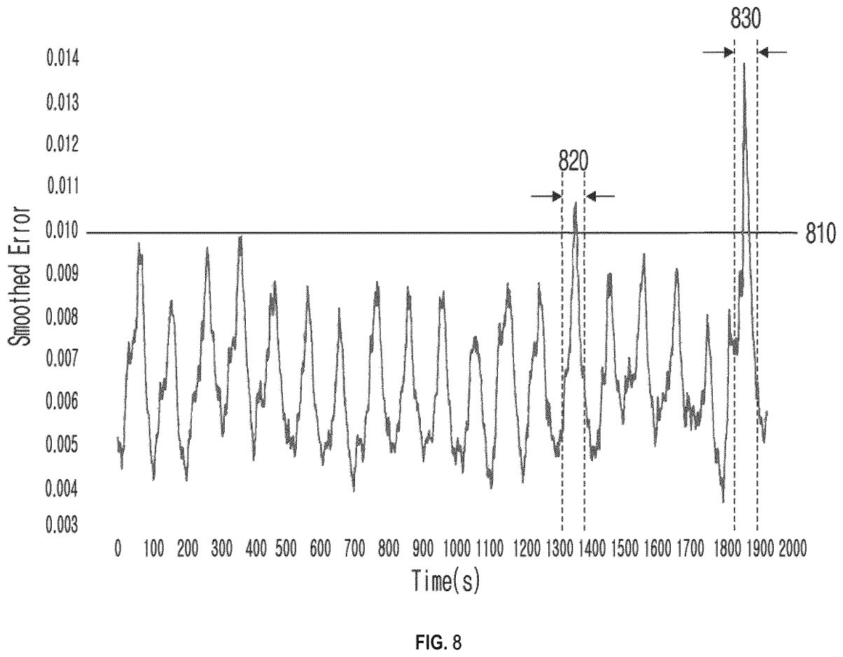

Referring back to FIG. 2, the average change detector 225 detects average change anomalies by sensing changes in the data over time from the received original data. The average change detector 225 uses an LSTM (Long Short-Term Memory) deep learning model to detect these anomalies. The detection method of the average change detector 225 is illustrated in FIG. 8.

FIG. 8 is a graph illustrating an example of an anomalous characteristic detected by the average change detector according to an embodiment of the present invention.

Referring to FIG. 8, the average change detector 225 uses LSTM to detect changes in time-series data. The average change detector 225 sets a reference value 810 corresponding to the normal range of data based on the original data input over a predetermined period (e.g., from a specific past time to the present) using LSTM. The average change detector 225 detects points where the input original data exceeds the reference value 810 as points of average change anomalies 820 and 830.

Alternatively, as previously described, the average change detector 225 can predict the trend of data changes based on the original data input over a predetermined period. If the current input original data differs from the predicted trend or if the difference exceeds a predetermined threshold, the average change detector 225 can detect it as an average change anomaly or an overshooting anomaly.

Referring back to FIG. 2, the anomaly detection apparatus 120 applies different deep learning models using different methods, enabling the detection of overshooting anomalies, anomalous oscillations, and average change anomalies with high accuracy. As a result, unlike conventional methods that only detect average changes, this device can detect most anomalies that may occur in industrial equipment.

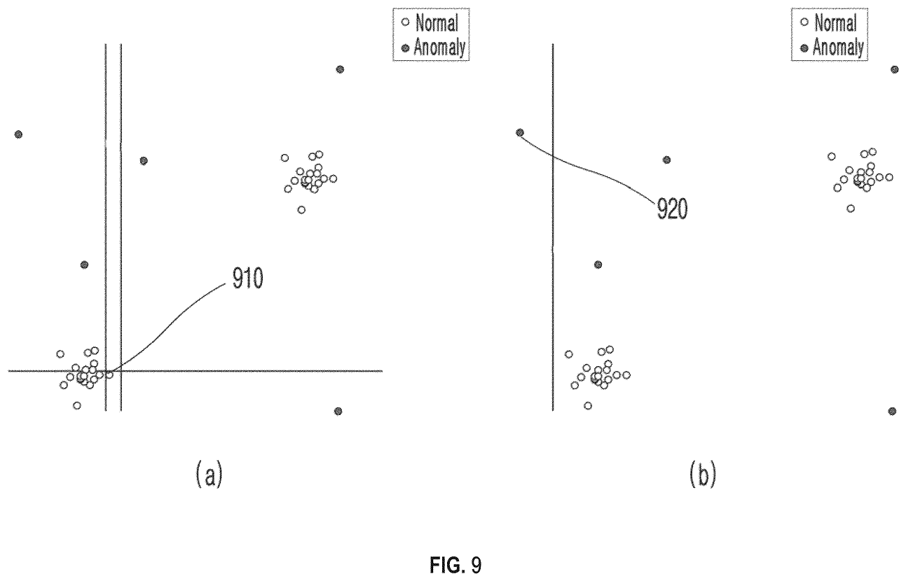

Additionally, the short-term anomaly detector 227 uses a machine learning model, Isolation Forest, to detect anomalies in the data within the original data. The short-term anomaly detector 227 distinguishes between normal data without anomalies and anomalous data with anomalies as illustrated in the method shown in FIG. 9.

FIG. 9 is a schematic diagram illustrating a method for detecting anomalous characteristics by the short-term data detector according to an embodiment of the present invention.

The short-term anomaly detector 227 isolates and partitions both normal data and anomalous data. As shown in FIG. 9 (a), normal data 910 requires a relatively large number of partitions (three in FIG. 9) to be isolated. Conversely, as shown in FIG. 9 (b), anomalous data requires fewer partitions (one in FIG. 9) to be isolated. Using this characteristic, the short-term anomaly detector 227 distinguishes between the two types of data based on whether the number of partitions needed to isolate the data exceeds a predetermined threshold. By leveraging this method, the short-term anomaly detector 227 can detect anomalies without the need for processes such as extracting and restoring data features or predicting data trend changes. This allows for the detection of anomalies without additional data processing steps. Furthermore, the short-term anomaly detector 227 does not require extensive training or only needs simple training for methods such as data partitioning. This makes it capable of detecting anomalies in industrial equipment even when there is a limited amount of training data available.

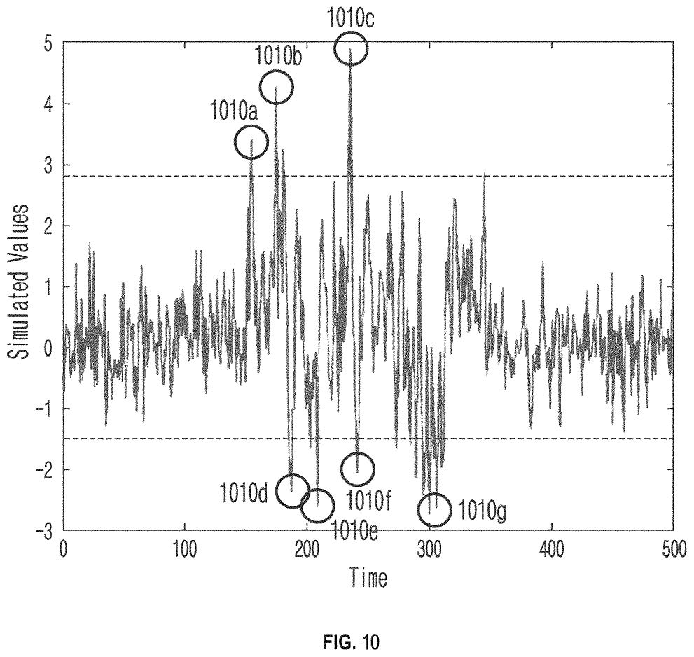

Referring back to FIG. 2, the long-term anomaly detector 229 uses a statistical model, the ARIMA model, to detect anomalies in the data within the original data. The long-term anomaly detector 229 employs a statistical model rather than a deep learning or machine learning model. Therefore, it does not require any training. Instead, it determines anomalies based on changes in statistical values over time from the original data received during a predetermined period. The detection process of the long-term anomaly detector 229 is illustrated in FIG. 10.

FIG. 10 is a graph illustrating an example of an anomalous characteristic detected by the long-term data detector according to an embodiment of the present invention.

Referring to FIG. 10, the long-term anomaly detector 229 calculates the statistical values of accumulated data over a specific period. For example, the long-term anomaly detector 229 computes statistical values such as the mean or standard deviation of data accumulated over several months or years. Based on these computed values, the long-term anomaly detector 229 establishes the normal range for the mean values of the original data.

Subsequently, the long-term anomaly detector 229 calculates the statistical values of the incoming original data over time. Instead of analyzing a single statistical value over a period, the long-term anomaly detector 229 analyzes changes in statistical values over time. By analyzing these changes, if the statistical values deviate from the established normal range, the long-term anomaly detector 229 identifies that an anomaly has occurred at those specific points in time (1010a to 1010g). Due to its reliance on the statistical values of long-term accumulated data, the long-term anomaly detector 229 can accurately detect anomalous increases or decreases in the mean values of the data.

Referring to FIGS. 2 to 10, the overshooting detector 221, oscillation detector 223, average change detector 225, short-term anomaly detector 227, and long-term anomaly detector 229 are described as using specific models for convenience. However, this is not a limitation. It is evident that a model used in one detector can be utilized to detect other types of anomalies. For instance, the detection results of the CNN model used by the overshooting detector 221 for detecting overshooting anomalies can also be employed for detecting anomalous oscillations or average change anomalies.

Referring back to FIG. 2, the controller 230 receives the original data from the industrial equipment and controls some or all of the detectors (221 to 229) to detect anomalies. If the user input unit 240 receives input from the administrator to primarily detect overshooting anomalies, the controller 230 can control the overshooting detector 221 or the average change detector 225 to detect anomalies from the original data. Alternatively, if the user input unit receives input to primarily detect anomalous increases or decreases in the average value, the controller 230 can control the average change detector 225 or the long-term anomaly detector 229 to detect anomalies from the original data. However, this is not restrictive, and the controller 230 can control all detectors to detect anomalies, even in such cases.

The controller 230 can receive threshold values for anomaly detection from the user input unit 240, allowing it to adjust the sensitivity of each detector (221 to 229) to anomalies. For example, as described with reference to FIG. 5, the overshooting detector 221 detects the presence of overshooting anomalies in the original data based on the difference between the original data and the restored value. The user input unit 240 can receive input from the administrator regarding the threshold for determining anomalies based on this difference. When the threshold is set higher, the criteria for judging the difference between the original data and the restored value as an anomaly become stricter, resulting in fewer detected anomalies but with increased accuracy. Conversely, when the threshold is set lower, the criteria become more lenient, resulting in more detected anomalies but with relatively decreased accuracy. The controller 230 can adjust the sensitivity of the detectors by setting the threshold for anomaly detection based on the input received from the user input unit 240. This allows for fine-tuning of the detection criteria to balance the number of detected anomalies and the accuracy of detection according to the needs of the administrator.

The user input unit 240 receives threshold values for anomaly detection from an external source (primarily the administrator). Additionally, the user input unit 240 can receive input regarding the types of anomalies to be detected from the external source.

By utilizing deep learning models, machine learning models, and statistical models, the anomaly detection apparatus 120 can detect various types of anomalies occurring in industrial equipment with relatively high accuracy. Additionally, even without separately training on data where anomalies have occurred, the device can achieve high accuracy in anomaly detection by training based on normal data The above description is merely illustrative of the technical ideas of the present embodiment, and various modifications and variations can be made by those skilled in the art without departing from the essential characteristics of the present embodiment. Therefore, the present embodiments are intended to be illustrative rather than limiting, and the scope of the present embodiment should not be limited by these embodiments. The scope of protection of the present embodiment should be interpreted based on the following claims, and all technical ideas within the equivalent scope should be considered to be included within the scope of the present embodiment.

1. An anomaly detection apparatus for detecting anomalies occurring in industrial equipment, comprising:
a communicator configured to receive an input value input into the industrial equipment or an output value output from the industrial equipment;
an anomaly detector configured to detect multiple types of anomalies occurring in the industrial equipment from the input value or output value received by the communicator; and
a controller configured to control the operations of the communicator and the anomaly detector.

2. The anomaly detection apparatus according to claim 1, wherein the anomaly detector comprises:
an overshooting detector configured to detect an overshooting anomaly occurring in the input value or output value;
an anomalous oscillation detector configured to detect an anomalous oscillation occurring in the input value or output value; and
an average change detector configured to detect an average change anomaly occurring in the input value or output value.

3. The anomaly detection apparatus according to claim 2, wherein the overshooting detector and the oscillation detector are configured to:
extract one or more feature points in a latent space from the input value or output value received from the industrial equipment, and
detect the overshooting anomaly or anomalous oscillation by using the difference between a restored value, which is restored from the extracted feature points, and the original input value or output value received from the industrial equipment.

4. The anomaly detection apparatus according to claim 3, wherein the overshooting detector is configured to:
extract one or more feature points in a latent space from the input value or output value received from the industrial equipment using a CNN model, and then restore the feature points.

5. The anomaly detection apparatus according to claim 3, wherein the oscillation detector is configured to:
extract one or more feature points in a latent space from the input value or output value received from the industrial equipment using an LSTM model, and then restore the feature points.

6. The anomaly detection apparatus according to claim 2, wherein the average change detector is configured to:
set a normal range corresponding to data without anomalies based on the input value or output value received from the industrial equipment over a predetermined period, and
detect an average change anomaly based on whether the input value or output value received from the industrial equipment deviates from the normal range.

7. The anomaly detection apparatus according to claim 2, wherein the average change detector is configured to:
predict the trend of data changes based on the input value or output value received from the industrial equipment over a predetermined period, and
detect an average change anomaly based on whether there is a difference between the input value or output value received from the industrial equipment and the predicted trend.

8. The anomaly detection apparatus according to claim 7, wherein the average change detector is configured to:
predict the trend of data changes based on the input value or output value received from the industrial equipment over a predetermined period using an LSTM model.

9. The anomaly detection apparatus according to claim 2, wherein the anomaly detector further comprises:
a short-term anomaly detector configured to detect anomalies in the data within the input value or output value received from the industrial equipment; and
a long-term anomaly detector configured to calculate statistics of the input value or output value received over a predetermined period, and detect anomalies in the input value or output value received from the industrial equipment using the calculated statistics.

10. The anomaly detection apparatus of claim 9, wherein the short-term anomaly detector uses a machine learning model.

11. The anomaly detection apparatus of claim 9, wherein the long-term anomaly detector uses a statistical model.

12. An anomaly detection system for industrial equipment, comprising:
industrial equipment;
an anomaly detection apparatus configured to receive an input value input into the industrial equipment or an output value output from the industrial equipment, detect multiple types of anomalies occurring in the industrial equipment from the received input value or output value, and transmit the detection results externally; and
an administrator terminal configured to receive information on the occurrence of anomalies in the industrial equipment from the anomaly detection apparatus and enable an administrator to manage the industrial equipment in which the anomalies have occurred.
